(19) United States
(12) Patent Application Publication
(10) Pub. No.: US 2013/0260730 A1
(43) Pub. Date: Oct. 3, 2013

(54) CUSTOM APPLICATION CONTAINER FOR MOBILE OPERATING SYSTEMS AND/OR DEVICES

(71) Applicants: Andrew Jong Kein Toy, New York, NY (US); Alexander Allan Trewby, London (GB); David Wei Zhu, Palo Alto, CA (US); Nadim Tawileh, New York, NY (US)

(72) Inventors: Andrew Jong Kein Toy, New York, NY (US); Alexander Allan Trewby, London (GB); David Wei Zhu, Palo Alto, CA (US); Nadim Tawileh, New York, NY (US)

(73) Assignee: ENTERPROID HK LTD, Hong Kong (CN)

(21) Appl. No.: 13/432,684

(22) Filed: Mar. 28, 2012

(51) Int. Cl. H04M 3/00

(52) U.S. Cl. 455/418

(57) ABSTRACT

Systems and methods for providing a custom application container for a mobile operating system are provided herein. A container that encapsulates an application layer of a mobile operating system can be provided. Thus, the container can include all applications that reside in the application layer and operate as a proxy for system calls issued by the applications to the mobile operating system. In particular, the container can intercept core service request and forward those requests to pluggable extensions relating to a core service requested by the core service request.

### CROSS-REFERENCE TO RELATED APPLICATIONS

This application is related to U.S. patent application Ser. No. 12/825,902, filed Jun. 29, 2010 and entitled REMOTE ACCESS TO A MOBILE DEVICE. This application is also related to U.S. patent application Ser. No. 12/974,478 filed Dec. 21, 2010 and entitled CONTEXTUAL ROLE AWARENESS. This application is also related to U.S. patent application Ser. No. 13/412,263 filed Mar. 5, 2012 and entitled ENHANCED DEPLOYMENT OF APPLICATIONS. The entireties of these applications are incorporated herein by reference.

### TECHNICAL FIELD

This disclosure generally relates to a configurable container for an applications layer of a mobile operating system or device.

### BACKGROUND

Mobile operating systems today provide a set of core services that are available to applications that are executing on an associated mobile device. A common example of a core service is a dialer. Generally, any application can generate a request to the mobile operating system to request the dialer in order to make a call. The operating system will then interpret the request, generally in accordance with a particular hardcoded implementation, and the dialer will enable the call. For example, a global system for mobile communication (GSM) phone will typically include a dialer that accesses a GSM radio. Likewise, a code division multiple access (CDMA) phone will typically leverage a CDMA radio.

Regardless of the type of phone and/or the implementation of the core service dialer, from the application's perspective, the dialer request that is issued to the mobile operating system is the same. Therefore, any application can access the dialer with a standard request in a seamless manner. However, the dialer core service performs a specific function according to its design implementation. Therefore, any application that seeks to invoke different functions is unable to utilize the core service dialer, and therefore unable to provide such different functionality in a seamless manner.

For example, numerous applications exist to leverage voice-over-Internet-protocol (VOIP) networks to make calls. Such applications can bypass the core services dialer in order to leverage different functionality, but will lose the seamless nature that comes with making calls with the dialer. Therefore, in order to access the VOIP network for a call, the VOIP application will first need to be downloaded and configured/installed by the user. In addition, the VOIP application will need to be invoked prior to making a call every time the VOIP network is desired. Merely dialing numbers will instead invoke the core service dialer. Likewise, for example, clicking on a phone number included in an email will also invoke the core service dialer, not the VOIP application.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems and methods disclosed herein relate to managing distribution of applications. A container component can be configured to provide a container that encapsulates an application layer of a mobile operating system. The container can be configured to interface to the mobile operating system, and can include a receiving component and a selection component. The receiving component can be configured to receive a core services request to access a core service of the mobile operating system from an application included in the container. The selection component can be configured to select an extension associated with the core services request. In addition, the selection component can also be configured to route the core services request to the extension

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level functional block diagram of an example system that utilizes a custom container;

FIG. 2 depicts a block diagram of numerous non-limiting examples of core services;

FIG. 3A illustrates a block diagram of various non-limiting examples of dialer extensions;

FIG. 3B illustrates a block diagram of various non-limiting examples of filesystem extensions;

FIG. 4 illustrates a functional block diagram depicting an example system that can provide additional features in connection with utilizing a custom container;

FIG. 5 illustrates an example methodology for providing a custom container in accordance with some embodiments of the disclosed subject matter;

FIG. 6 illustrates an example wireless communication environment with associated components that can enable operation of an enterprise network in accordance with aspects described herein;

FIG. 7 illustrates a block diagram of a computer operable to execute or implement all or portions of the disclosed architecture; and

FIG. 8 illustrates a schematic block diagram of an exemplary computing environment.

### DETAILED DESCRIPTION

### Overview

Systems and methods disclosed herein relate to utilizing a custom application container for mobile operating systems and/or mobile devices. The container can represent an environment or ecosystem for a mobile device or for a user or group of users. For example, the container can encapsulate the applications layer of a mobile operating system. Any requests/calls issued by an application included in the container can be intercepted by the container, which can then forward those requests to the operating system or to an extension that can be included in the container. Thus, additional functionality over the existing operating system can be provided by way of various configurable extensions. Moreover, these extensions can be pluggable and/or swappable, and can provide such additional functionality in a seamless manner. Furthermore, these extensions can be invoked based upon various criteria that can be defined by a policy. Extensions can also be selected (e.g., from among multiple different extensions) based upon the criteria and/or policy.

For example, some extensions can become available based upon characteristics of the underlying device (e.g., device type, model, capabilities, etc.). For instance, extensions associated with biometric sensors might not be available if the host mobile device does not include requisite biometric hardware. However, those same extensions can be available if the necessary hardware does exist.

Based upon the policy, a company administrator or other authorized party can designate, change, or restrict options that are available for a user of the mobile device. For example, a company administrator might configure various extensions of a container such that all mobile devices associated with his or her employees behave in a certain manner. Thus, consider the scenario in which the admin decides for security reason that all data associated with employee mobile devices will be saved on a company cloud server instead of a flash drive or secure digital (SD) card. Common examples of such data are email attachments or photos snapped by the mobile device. In conventional systems, associated applications (e.g., email application, camera application, etc.) would send a request to the mobile operating system for a filesystem handle. However, in embodiments of the disclosed subject matter, the container will intercept this request and route it to the appropriate extension. In this case, that extension will provide a destination of the secure company cloud server rather than a flash drive, SD card, or other local data store, and such a result (configured by the company admin) can be achieved in a seamless manner, both for users and applications running on the mobile device. For instance, the user will not be required to load a separate application prior to saving an email attachment or data from a camera.

As another example, the company administrator might choose to restrict and/or route contacts calls to a company salesforce database instead of the database associated with a contacts core service. As yet another example, the company administrator might first designate an extension that requires all calls to be routed through a company server, but later change this policy. Following the change, calls can be routed through the normal dialer core service.

Additionally or alternatively, users/owners of the mobile device and/or a secure persona on the mobile device can configure extensions as well. In the case where a company administrator has a higher priority than the actual user of the mobile device (e.g., when the user is an employee and the secure persona is company-managed), then absent any policy criteria defined by the company administrator, the user can define such policy criteria and/or the criteria can be based upon a default configuration, potentially based upon usability or business conditions.

### Custom Containers

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

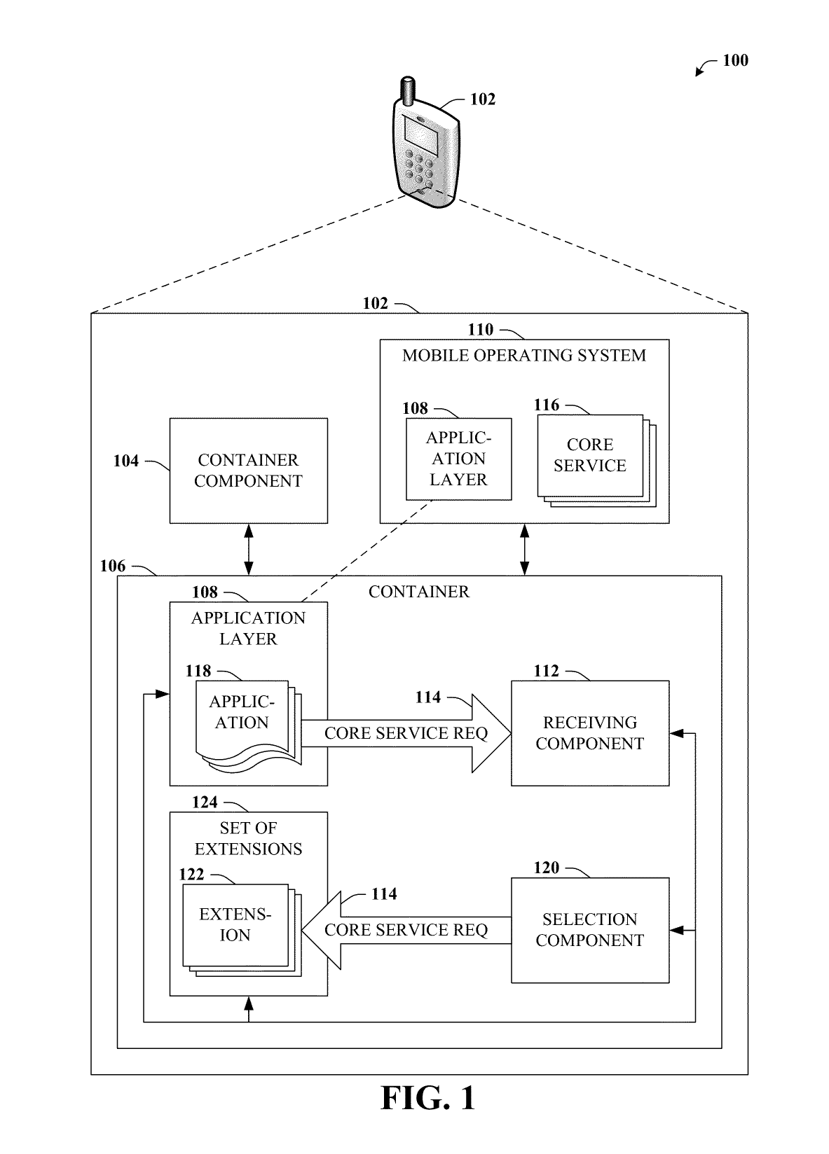

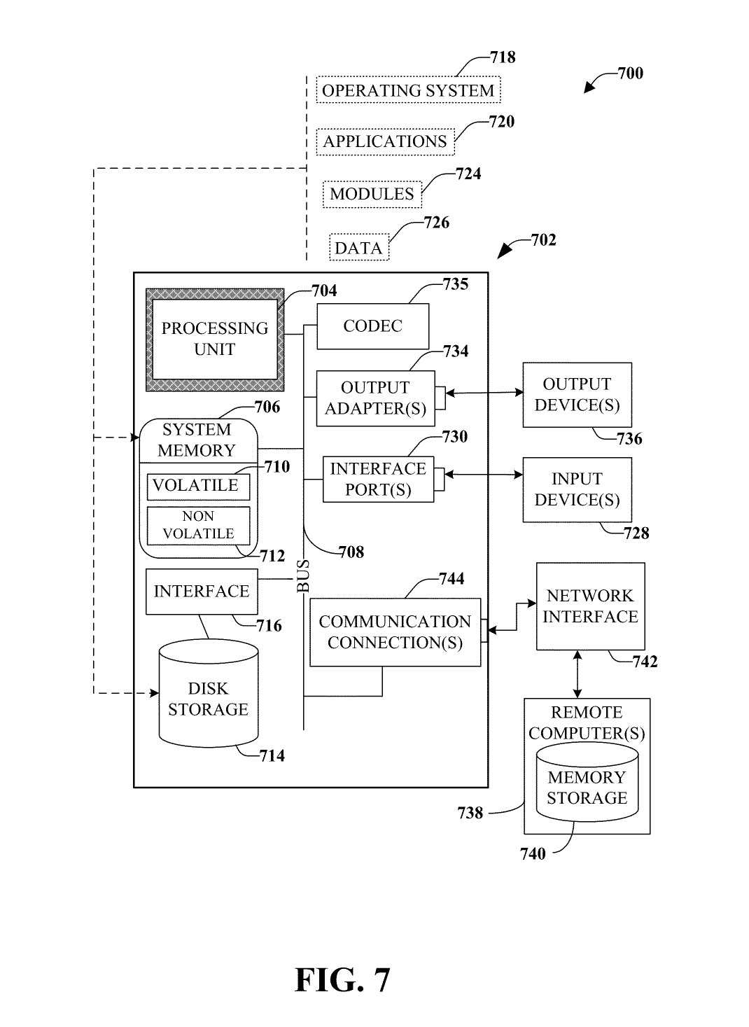

Referring now to FIG. 1, system 100 that utilizes a custom container is depicted. System 100 can include mobile device 102 that can be for example, a smart phone, a tablet, a personal digital assistant (PDA), or substantially any device that utilizes a mobile operating system. Mobile device 102 can include a memory and a processor, examples of which are provided in connection with FIG. 7. Moreover, the processor can be configured to execute various components described herein.

Mobile device 102 can include container component 104 that can be configured to provide container 106. Container 106 can be configured to encapsulate application layer 108 of mobile operating system 110 and to interface to mobile operating system 110. By encapsulating application layer 108, container 106 can act as a proxy for any application (e.g., application(s) 118) included in application layer 108, and particularly as a proxy for calls to mobile operating system 110 made by any of these applications.

In certain embodiments, container 106 can include receiving component 112 and selection component 120. Receiving component 112 can be configured to receive core service request 114 to access a core service 116 of mobile operating system 110 from an application 118 included in container 106. For example, a camera application (e.g., application 118) might issue core service request 114 to access the filesystem (e.g., core service 116) in order to save a photo. In conventional systems, such requests will be received by the operating system, however, in accordance with the disclosed subject matter, container 106, and particularly receiving component 112, can intercept the core service request 114.

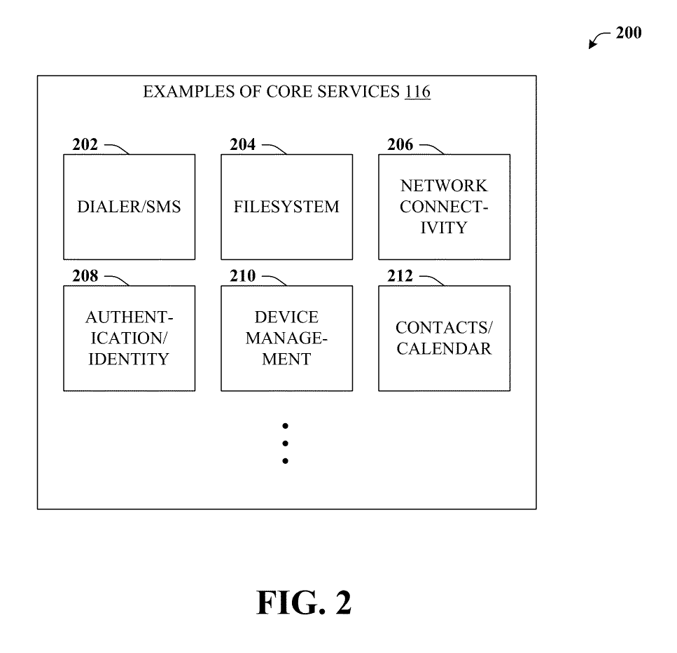

While still referring to FIG. 1, but turning now as well to FIG. 2, various examples of core services are provided by illustration 200. For example, a common core service 116 provided by mobile operating system 110 can be a dialer function or a short message service (SMS) function, which is represented by reference numeral 202. The dialer function typically handles outgoing calls from mobile device 102. The SMS function typically handles, e.g., text messages. Another example core service 116 is filesystem 204. Filesystem 204 provides functions associated with accessing or storing information. For instance, applications 118 typically access filesystem 204 core service to save an email attachment or a photo snapped by a camera of mobile device 102. Network connectivity 206 represents yet another example of a core service 116 provided by mobile operating system 110. For example, a virtual private network (VPN) or a proxy network might represent network connectivity 206.

Authentication/Identity 208 (e.g., passwords, credentials, biometric, etc.) represents still another example core service 116. Device management 210 can also be a core service 116 provided by mobile operating system 110 as can functions associated with contacts/calendar 212. It is understood that the examples of core services 116 provided herein are intended to be non-limiting, and numerous other examples are possible.

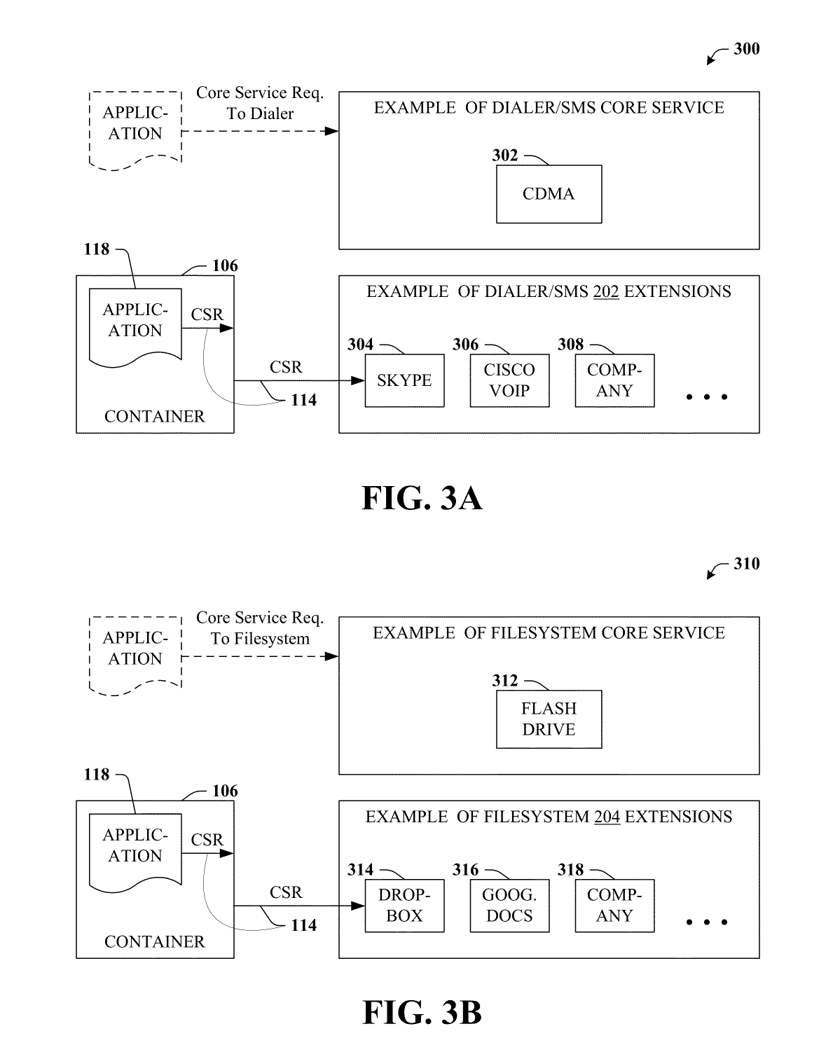

Still referring to FIG. 1, selection component 120 can be configured to select an extension 122 associated with core service request 114. In some embodiments, extension 122 can be selected from among many related or unrelated extensions, which is represented by set of extensions 124 and is further detailed with reference to FIG. 3. Selection component 120 can further be configured to route the core service request 114 to the selected extension 122. As such set of extensions 124 and/or an individual extension 122 can be thought of as a pluggable, swappable module that can seamlessly (both to users and applications 118) integrate with mobile operating system 110 in order to provide additional functionality and/or security or control. Such can be accomplished by virtualizing one or more core services 116 associated with core service request 114. Extension 122 can represent such a virtualization.

For example, turning to FIGS. 3A and 3B, example scenarios are provided for two specific core services. Illustration 200 of FIG. 2 provides numerous non-limiting example of core services 116. From these numerous examples, the first two are now described in more detail and it is appreciated that one of skill in the art can readily understand similar features can be applicable to other core services 116 provided by mobile operating system 110.

With particular reference to FIG. 3A, illustration 300 depicts an example scenario in which the core service call relates to a core service dialer (e.g., dialer/SMS 202). In conventional approaches (depicted in the upper portion of illustration 300) an application running on the mobile device will make a core service request to the dialer core service. Depending on the implementation of the mobile device, this core service request will invoke the standard dialer function, which in this case is a code division multiple access radio represented by CDMA 302. Therefore, all applications will use CDMA 302 when invoking the core service dialer.

In contrast, the lower portion of illustration 300 depicts an example embodiment of the disclosed subject matter. Application 118 can issue core service request 114. However, rather than going to the operating system to invoke the standard dialer, core service request 114 can be intercepted by container 106. In particular, receiving component 112 included in container 106 can intercept core service request 114. Likewise, selection component 120 can select the appropriate extension 122 in which to forward core service request 114.

Since this particular core service request 114 is related to the dialer core service (e.g., dialer/SMS 202), selection component 120 can select from among various extensions 122 that are also related to dialer functionality. For example, Skype service 304, Cisco VOIP service 306, and a company VOIP service 308 are straightforward examples. In this example, Skype 304 is selected as the appropriate extension. As a result, any activity or behavior that would in conventional systems have invoked CDMA 302 will now instead invoke Skype. Application 118 need not be related to or even aware that Skype services are being leveraged. Hence, virtually limitless additional functionality can be provided to a given mobile device in a manner that is seamless to users and applications. Moreover, such additional functionality can be tailored to particular needs such as, e.g., enterprise policies and procedures or the like.

With particular reference to FIG. 3B, illustration 310 depicts an example scenario in which the core service call relates to a filesystem request (e.g., filesystem 204). In conventional approaches (depicted in the upper portion of illustration 310) an application running on the mobile device will make a core service request to the filesystem for a variety of reasons such as to save data (e.g., email, contacts, photos) or otherwise access saved data. Depending on the implementation of the mobile device, this core service request will invoke the standard filesystem function, which in this case relates to a filesystem structure included on flash drive 312.

In contrast, the lower portion of illustration 310 depicts an example embodiment of the disclosed subject matter. Application 118 can issue core service request 114. However, rather than going to the operating system in order to determine where to save or access data, core service request 114 can be intercepted by container 106 (e.g., by way of receiving component 112). Likewise, container 106 (e.g., by way of selection component 120) can select the appropriate extension 122 in which to forward core service request 114.

As this particular core service request 114 is related to the filesystem (e.g., filesystem 204), selection component 120 can select from among various extensions 122 that are also related to filesystem functionality. For example, rather than saving the associated data to flash drive 312, which would be done conventionally, data can be saved to (or retrieved from), e.g., a cloud. Common examples of cloud-based storage are Dropbox 314, GoogleDocs 316, or a company-based facility 318.

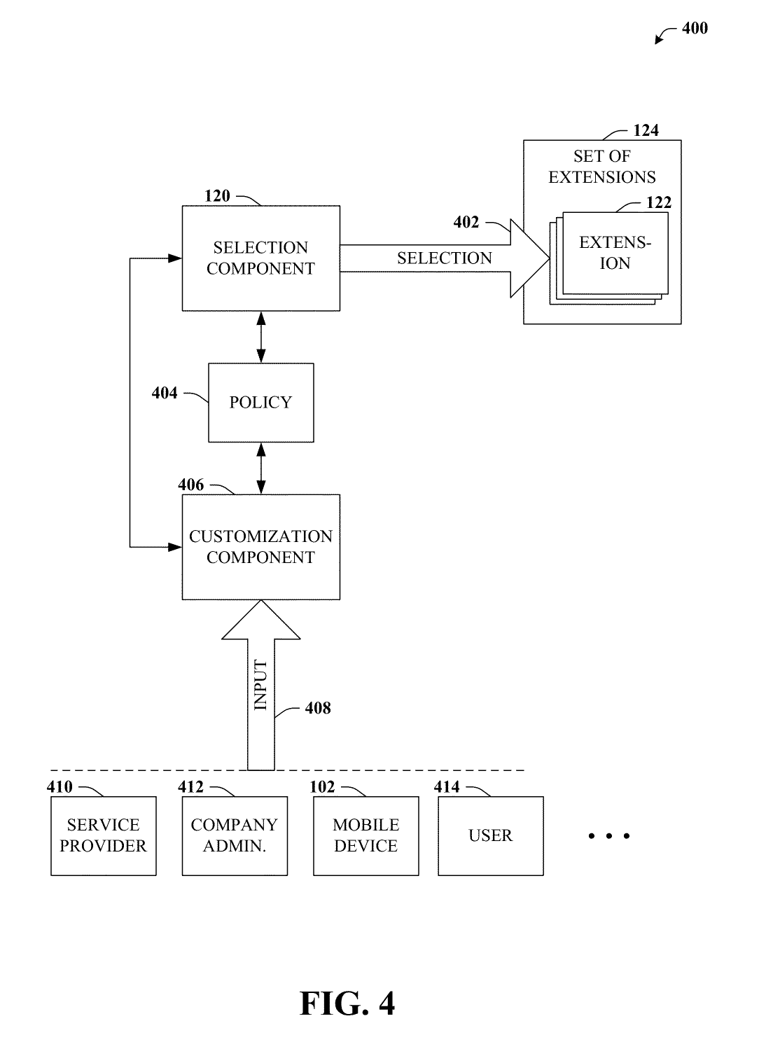

Thus, it is understood that for any given core service 116 provided by mobile operating system 110, virtually any number of extensions 122 can exist that can seamlessly replace the functionality of that core service and any one of those extensions 122 can be selected based upon the configuration of container 106. Therefore, in certain embodiments, selection component 120 can select the appropriate extension 122 based upon a policy, as further detailed in connection with FIG. 4.

With reference now to FIG. 4, system 400 is depicted. System 400 provides additional features in connection with utilizing a custom container. System 400 can include selection component 120 as well as all or a portion of other components or features detailed herein. As described in connection with system 100 of FIG. 1, selection component 120 can be configured to select extension 122 associated with core service request 114. Such is depicted here as selection 402.

In some embodiments, selection component 120 can be configured to select extension 122 based upon policy 404 that is included in or accessible to container 106. Furthermore, system 400 can also include customization component 406 that can be included in container 106. Customization component can configure policy 404 based upon input 408. Such input 408 can be received by customization component 406 from service provider 410 (e.g., an entity that provides the extensions 122 or related services or an entity that provides phone communications services), from a company administrator 412 (e.g., an entity that manages phone services for its employees), from mobile device 102 (e.g., from a different persona included in mobile device 102, such as an admin persona or the like), from user 414 (e.g., the owner/operator of mobile device 102), and so on.

It is understood, that a single mobile device can include various personas, which are further detailed herein by reference. However, briefly, a mobile device (e.g., mobile device 102) can include multiple personas for one or a group of users, where a persona relates to a contextual role of the user or group of users. For example, a particular user can maintain an enterprise persona, a personal persona, a gaming persona or the like. Each persona can be independent of others, thus, data such as contacts or the particular set of applications installed, etc. can be distinct, not overlapping and not being accessible from a different persona. Such data that is accessed by way of a core service call can therefore differ based upon which persona is active. In addition, the container associated with a given persona can therefore be different from the container associated with a different persona. Hence, not only can data change when switching from one role to another (e.g., the results of an application that displays contacts will change, seamlessly to the application), the container can change as well. Thus, changing personas can change the policy for how particular core service calls are handled. For example, instance the same application that displays contacts might not only pull those contacts from a different database, but might do so in a different manner (e.g., collect data from a cloud server rather than a local flash drive).

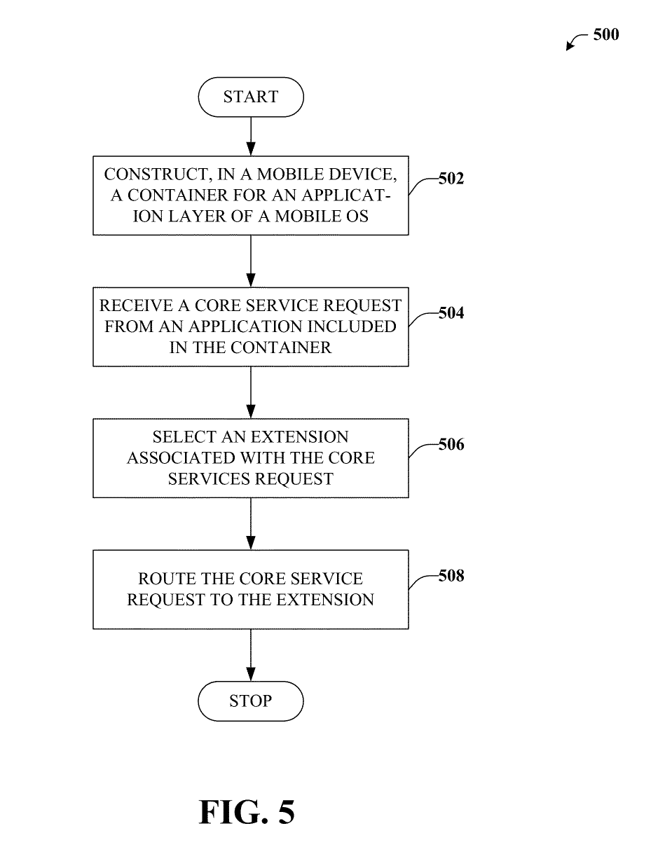

FIG. 5 illustrates various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers

Referring now to FIG. 5, exemplary method 500 for providing a custom container is depicted. Generally, at reference numeral 502, a container can be constructed in a mobile device or otherwise invoked or provided. This container can be configured to encapsulate an application layer of a mobile operating system. Thus, applications that reside in the application layer can also be encapsulated by the container.

At reference numeral 504, a core service request to access a core service of the mobile operating system can be received from an application included in the container. In traditional systems, such requests typically go to the mobile operating system, yet in accordance with embodiments described herein, the request can instead be intercepted by the container.

At reference numeral 506, an extension associated with the core service request can be selected. For example, if the core service request is associated with a dialer function of the mobile operating system, then the selected extension can also be related to dialer functionality. At reference numeral 508, the core service request can be routed to the extension selected at reference numeral 506.

### Example Operating Environments

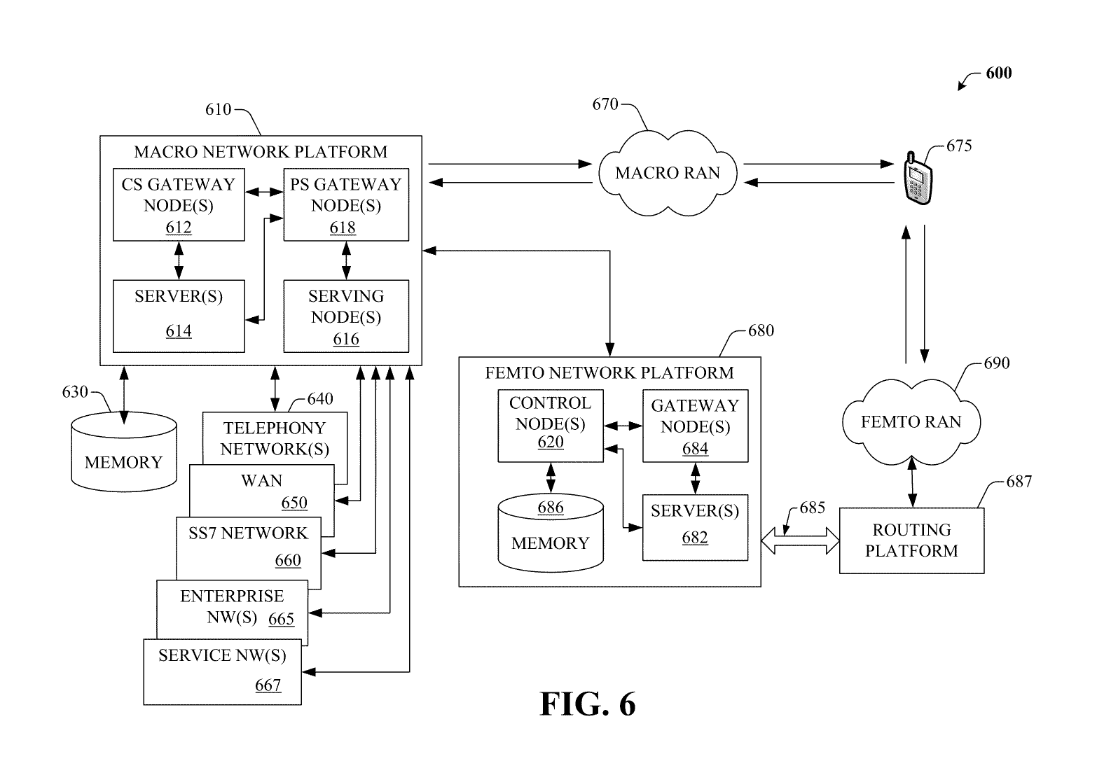

To provide further context for various aspects of the subject specification, FIG. 6 illustrates an example wireless communication environment 600, with associated components that can enable operation of a femtocell enterprise network in accordance with aspects described herein. Wireless communication environment 600 includes two wireless network platforms: (i) A macro network platform 610 that serves, or facilitates communication) with user equipment 675 via a macro radio access network (RAN) 670. It should be appreciated that in cellular wireless technologies (e.g., 4G, 3GPP UMTS, HSPA, 3GPP LTE, 3GPP UMB), macro network platform 610 is embodied in a Core Network. (ii) A femto network platform 680, which can provide communication with UE 675 through a femto RAN 690, linked to the femto network platform 680 through a routing platform 62 via backhaul pipe(s) 685. It should be appreciated that femto network platform 680 typically offloads UE 675 from macro network, once UE 675 attaches (e.g., through macro-to-femto handover, or via a scan of channel resources in idle mode) to femto RAN.

It is noted that RAN includes base station(s), or access point(s), and its associated electronic circuitry and deployment site(s), in addition to a wireless radio link operated in accordance with the base station(s). Accordingly, macro RAN 670 can comprise various coverage cells like cell 1105, while femto RAN 690 can comprise multiple femto access points. As mentioned above, it is to be appreciated that deployment density in femto RAN 690 is substantially higher than in macro RAN 670.

Generally, both macro and femto network platforms 610 and 680 include components, e.g., nodes, gateways, interfaces, servers, or platforms, that facilitate both packet-switched (PS) (e.g., internet protocol (IP), frame relay, asynchronous transfer mode (ATM)) and circuit-switched (CS) traffic (e.g., voice and data) and control generation for networked wireless communication. In an aspect of the subject innovation, macro network platform 610 includes CS gateway node(s) 612 which can interface CS traffic received from legacy networks like telephony network(s) 640 (e.g., public switched telephone network (PSTN), or public land mobile network (PLMN)) or a SS7 network 660. Circuit switched gateway 612 can authorize and authenticate traffic (e.g., voice) arising from such networks. Additionally, CS gateway 612 can access mobility, or roaming, data generated through SS7 network 660; for instance, mobility data stored in a VLR, which can reside in memory 630. Moreover, CS gateway node(s) 612 interfaces CS-based traffic and signaling and gateway node(s) 618. As an example, in a 3GPP UMTS network, gateway node(s) 618 can be embodied in gateway GPRS support node(s) (GGSN).

In addition to receiving and processing CS-switched traffic and signaling, gateway node(s) 618 can authorize and authenticate PS-based data sessions with served (e.g., through macro RAN) wireless devices. Data sessions can include traffic exchange with networks external to the macro network platform 610, like wide area network(s) (WANs) 650; it should be appreciated that local area network(s) (LANs) can also be interfaced with macro network platform 610 through gateway node(s) 618. Gateway node(s) 618 generates packet data contexts when a data session is established. To that end, in an aspect, gateway node(s) 618 can include a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can include multiple flows that can be generated through server(s) 614. It is to be noted that in 3GPP UMTS network(s), gateway node(s) 618 (e.g., GGSN) and tunnel interface (e.g., TTG) comprise a packet data gateway (PDG).

Macro network platform 610 also includes serving node(s) 616 that convey the various packetized flows of information or data streams, received through gateway node(s) 618. As an example, in a 3GPP UMTS network, serving node(s) can be embodied in serving GPRS support node(s) (SGSN).

As indicated above, server(s) 614 in macro network platform 610 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can include add-on features to standard services provided by macro network platform 610. Data streams can be conveyed to gateway node(s) 618 for authorization/authentication and initiation of a data session, and to serving node(s) 616 for communication thereafter. Server(s) 614 can also effect security (e.g., implement one or more firewalls) of macro network platform 610 to ensure network's operation and data integrity in addition to authorization and authentication procedures that CS gateway node(s) 612 and gateway node(s) 618 can enact. Moreover, server(s) 614 can provision services from external network(s), e.g., WAN 650, or Global Positioning System (GPS) network(s) (not shown). It is to be noted that server(s) 614 can include one or more processor configured to confer at least in part the functionality of macro network platform 610. To that end, the one or more processor can execute code instructions stored in memory 630, for example.

In example wireless environment 600, memory 630 stores information related to operation of macro network platform 610. Information can include business data associated with subscribers; market plans and strategies, e.g., promotional campaigns, business partnerships; operational data for mobile devices served through macro network platform; service and privacy policies; end-user service logs for law enforcement; and so forth. Memory 630 can also store information from at least one of telephony network(s) 640, WAN(s) 650, or SS7 network 660, enterprise NW(s) 665, or service NW(s) 667.

Femto gateway node(s) 684 have substantially the same functionality as PS gateway node(s) 618. Additionally, femto gateway node(s) 684 can also include substantially all functionality of serving node(s) 616. In an aspect, femto gateway node(s) 684 facilitates handover resolution, e.g., assessment and execution. Further, control node(s) 620 can receive handover requests and relay them to a handover component (not shown) via gateway node(s) 684. According to an aspect, control node(s) 620 can support RNC capabilities.

Server(s) 682 have substantially the same functionality as described in connection with server(s) 614. In an aspect, server(s) 682 can execute multiple application(s) that provide service (e.g., voice and data) to wireless devices served through femto RAN 690. Server(s) 682 can also provide security features to femto network platform. In addition, server(s) 682 can manage (e.g., schedule, queue, format . . . ) substantially all packetized flows (e.g., IP-based, frame relay-based, ATM-based) it generates in addition to data received from macro network platform 610. It is to be noted that server(s) 682 can include one or more processor configured to confer at least in part the functionality of macro network platform 610. To that end, the one or more processor can execute code instructions stored in memory 686, for example.

Memory 686 can include information relevant to operation of the various components of femto network platform 680. For example operational information that can be stored in memory 686 can comprise, but is not limited to, subscriber information; contracted services; maintenance and service records; femto cell configuration (e.g., devices served through femto RAN 690; access control lists, or white lists); service policies and specifications; privacy policies; add-on features; and so forth.

It is noted that femto network platform 680 and macro network platform 610 can be functionally connected through one or more reference link(s) or reference interface(s). In addition, femto network platform 680 can be functionally coupled directly (not illustrated) to one or more of external network(s) 640, 650, 660, 665 or 667. Reference link(s) or interface(s) can functionally link at least one of gateway node(s) 684 or server(s) 686 to the one or more external networks 640, 650, 660, 665 or 667. The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 7, a suitable environment 700 for implementing various aspects of the claimed subject matter includes a computer 702. The computer 702 includes a processing unit 704, a system memory 706, a codec 705, and a system bus 708. The system bus 708 couples system components including, but not limited to, the system memory 706 to the processing unit 704. The processing unit 704 can be any of various available processors. Dual microprocessors and other multiprocessor architectures also can be employed as the processing unit 704.

The system bus 708 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 706 includes volatile memory 710 and non-volatile memory 712. The basic input/output system (BIOS), containing the basic routines to transfer information between elements within the computer 702, such as during start-up, is stored in non-volatile memory 712. In addition, according to present innovations, codec 705 may include at least one of an encoder or decoder, wherein the at least one of an encoder or decoder may consist of hardware, a combination of hardware and software, or software. Although, codec 705 is depicted as a separate component, codec 705 may be contained within non-volatile memory 712. By way of illustration, and not limitation, non-volatile memory 712 can include read only memory (ROM), programmable ROM (PROM), electrically programmable ROM (EPROM), electrically erasable programmable ROM (EEPROM), or flash memory. Volatile memory 710 includes random access memory (RAM), which acts as external cache memory. According to present aspects, the volatile memory may store the write operation retry logic (not shown in FIG. 7) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 702 may also include removable/non-removable, volatile/non-volatile computer storage medium. FIG. 7 illustrates, for example, disk storage 714. Disk storage 714 includes, but is not limited to, devices like a magnetic disk drive, solid state disk (SSD) floppy disk drive, tape drive, Jaz drive, Zip drive, LS-100 drive, flash memory card, or memory stick. In addition, disk storage 714 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 714 to the system bus 708, a removable or non-removable interface is typically used, such as interface 716.

It is to be appreciated that FIG. 7 describes software that acts as an intermediary between users and the basic computer resources described in the suitable operating environment 700. Such software includes an operating system 718. Operating system 718, which can be stored on disk storage 714, acts to control and allocate resources of the computer system 702. Applications 720 take advantage of the management of resources by operating system 718 through program modules 724, and program data 726, such as the boot/shutdown transaction table and the like, stored either in system memory 706 or on disk storage 714. It is to be appreciated that the claimed subject matter can be implemented with various operating systems or combinations of operating systems.

A user enters commands or information into the computer 702 through input device(s) 728. Input devices 728 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 704 through the system bus 708 via interface port(s) 730. Interface port(s) 730 include, for example, a serial port, a parallel port, a game port, and a universal serial bus (USB). Output device(s) 736 use some of the same type of ports as input device(s) 728. Thus, for example, a USB port may be used to provide input to computer 702 and to output information from computer 702 to an output device 736. Output adapter 734 is provided to illustrate that there are some output devices 736 like monitors, speakers, and printers, among other output devices 736, which require special adapters. The output adapters 734 include, by way of illustration and not limitation, video and sound cards that provide a means of connection between the output device 736 and the system bus 708. It should be noted that other devices and/or systems of devices provide both input and output capabilities such as remote computer(s) 738.

Computer 702 can operate in a networked environment using logical connections to one or more remote computers, such as remote computer(s) 738. The remote computer(s) 738 can be a personal computer, a server, a router, a network PC, a workstation, a microprocessor based appliance, a peer device, a smart phone, a tablet, or other network node, and typically includes many of the elements described relative to computer 702. For purposes of brevity, only a memory storage device 740 is illustrated with remote computer(s) 738. Remote computer(s) 738 is logically connected to computer 702 through a network interface 742 and then connected via communication connection(s) 744. Network interface 742 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 744 refers to the hardware/software employed to connect the network interface 742 to the bus 708. While communication connection 744 is shown for illustrative clarity inside computer 702, it can also be external to computer 702. The hardware/software necessary for connection to the network interface 742 includes, for exemplary purposes only, internal and external technologies such as, modems including regular telephone grade modems, cable modems and DSL modems, ISDN adapters, and wired and wireless Ethernet cards, hubs, and routers.

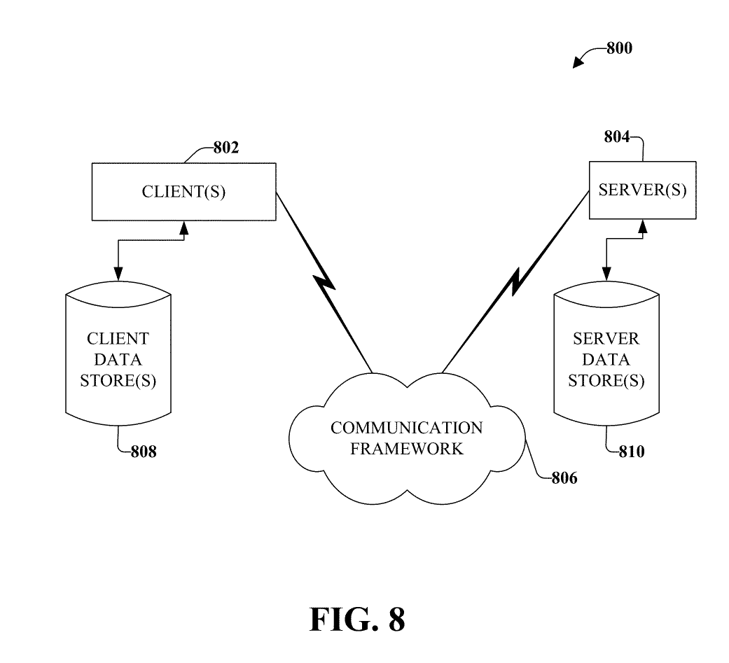

Referring now to FIG. 8, there is illustrated a schematic block diagram of a computing environment 800 in accordance with this specification. The system 800 includes one or more client(s) 802 (e.g., laptops, smart phones, PDAs, media players, computers, portable electronic devices, tablets, and the like). The client(s) 802 can be hardware and/or software (e.g., threads, processes, computing devices). The system 800 also includes one or more server(s) 804. The server(s) 804 can also be hardware or hardware in combination with software (e.g., threads, processes, computing devices). The servers 804 can house threads to perform transformations by employing aspects of this disclosure, for example. One possible communication between a client 802 and a server 804 can be in the form of a data packet transmitted between two or more computer processes wherein the data packet may include video data. The data packet can include a cookie and/or associated contextual information, for example. The system 800 includes a communication framework 806 (e.g., a global communication network such as the Internet, or mobile network(s)) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

In one embodiment, a client 802 can transfer an encoded file, in accordance with the disclosed subject matter, to server 804. Server 804 can store the file, decode the file, or transmit the file to another client 802. It is to be appreciated, that a client 802 can also transfer uncompressed file to a server 804 and server 804 can compress the file in accordance with the disclosed subject matter. Likewise, server 804 can encode video information and transmit the information via communication framework 806 to one or more clients 802.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

What is claimed is:

1. A system that utilizes a custom container, comprising:
a mobile device including a processor that executes the following computer executable components stored in a memory:
a container component that provides a container that encapsulates an application layer of a mobile operating system and interfaces to the mobile operating system, the container including:
a receiving component that receives a core service request to access a core service of the mobile operating system from an application included in the container; and
a selection component that selects an extension associated with the core service request and routes the core service request to the extension.

2. The system of claim 1, wherein the core service relates to at least one of a filesystem for the mobile operating system, network connectivity associated with the mobile operating system, a dialer for the mobile operating system, a short message service (SMS) for the mobile operating system, authentication or identity management for the mobile operating system, device management associated with the mobile operating system, or a contacts data provider.

3. The system of claim 1, wherein the extension virtualizes a core service associated with the core service request.

4. The system of claim 1, wherein the selection component selects the extension based upon a policy included in the container.

5. The system of claim 4, further comprising a customization component that can configure the policy based upon input.

6. The system of claim 5, wherein the input is received from at least one of a service provider, a company administrator, the mobile device, or a user of the mobile device.

7. The system of claim 1, the mobile device further comprising multiple personas, wherein a persona from among the multiple personas represents an operating environment for a contextual role associated with one or more users of the mobile device.

8. The system of claim 7, wherein the container component provides a distinct container for respective personas included in the mobile device.

9. A method for providing a custom container, comprising:
constructing, in a mobile device, a container that encapsulates an application layer of a mobile operating system;
receiving a core service request to access a core service of the mobile operating system from an application included in the container:
selecting an extension associated with the core service request; and
routing the core service request to the extension.

10. The method of claim 9, wherein the selecting an extension relates to selecting the extension from among multiple extensions that virtualize a core service associated with the core service request.

11. The method of claim 9, wherein the core service that is virtualized by the multiple extensions is at elast one of a filesystem for the mobile operating system, network connectivity associated with the mobile operating system, a dialer for the mobile operating system, a short message service (SMS) for the mobile operating system, authentication or identity management for the mobile operating system, device management associated with the mobile operating system, or a contacts data provider.

12. The method of claim 9, wherein the selecting an extension is based upon a policy.

13. The method of claim 12, further comprising configuring the policy based upon input received by the container.

14. The method of claim 13, further comprising receiving the input from at least one of a service provider, a company administrator, the mobile device, or a user of the mobile device.

15. A system for providing a custom container, comprising:
means for constructing, in a mobile device, a container that encapsulates an application layer of a mobile operating system;
means for receiving a core service request to access a core service of the mobile operating system from an application included in the container:
means for selecting an extension associated with the core service request; and
means for routing the core service request to the extension.

16. The system of claim 15, wherein the means for selecting an extension relates to selecting the extension from among multiple extensions that virtualize a core service associated with the core service request.

17. The method of claim 16, wherein the core service that is virtualized by the multiple extensions is at elast one of a filesystem for the mobile operating system, network connectivity associated with the mobile operating system, a dialer for the mobile operating system, a short message service (SMS) for the mobile operating system, authentication or identity management for the mobile operating system, device management associated with the mobile operating system, or a contacts data provider.

18. The method of claim 15, wherein the means for selecting an extension is based upon a policy.

19. The method of claim 18, further comprising means for configuring the policy based upon input received by the container.

20. The method of claim 19, further comprising means for receiving the input from at least one of a service provider, a company administrator, the mobile device, or a user of the mobile device.
